(19) United States
(12) Patent Application Publication
(10) Pub. No.: US 2012/0324573 A1
(43) Pub. Date: Dec. 20, 2012

(54) METHOD FOR DETERMINING WHETHER OR NOT SPECIFIC NETWORK SESSION IS UNDER DENIAL-OF-SERVICE ATTACK AND METHOD FOR THE SAME

(75) Inventors: Dae Won KIM, Daejeon (KR); Yang Seo Choi, Daejeon (KR); Ik Kyun Kim, Daejeon (KR)

(73) Assignee: Electronics and Telecommunications Research Institute, Daejeon (KR)

(21) Appl. No.: 13/453,968

(22) Filed: Apr. 23, 2012

(30) Foreign Application Priority Data
Jun. 20, 2011 (KR) 10-2011-0059641

(51) Int. Cl. G06F 21/00; G06F 11/00

(52) U.S. Cl. 726/22

(57) ABSTRACT

Provided is an apparatus and method for determining whether or not a specific network session is under a denial-of-service (DoS) attack. The method includes detecting a packet transmitted in the session, initializing the number of attack-suspicion continuation packets, increasing the number of attack-suspicion continuation packets by a predetermined number, and determining that the session is under the DoS attack.

### CLAIM FOR PRIORITY

This application claims priority to Korean Patent Application No. 10-2011-0059641 filed on Jun. 20, 2011 in the Korean Intellectual Property Office (KIPO), the entire contents of which are hereby incorporated by reference.

### BACKGROUND

1. Technical Field

Example embodiments of the present invention relate in general to an apparatus and method for determining whether or not a specific network session is under a denial-of-service attack, and more specifically to a method of detecting and coping with a denial-of-service (DoS) attack through which service resources are exhausted by occupying a session for a long time using a small amount of attack traffic.

2. Related Art

A DoS attack is aimed at maliciously attacking a system to exhaust resources of the system and hinder the system from being used for an intended use. The DoS attack may include preventing general users from normally using a service provided from a specific server by doing an amount of access trial to the specific server, or exhausting a transmission control protocol (TCP) connection of the specific server and so on.

Normally, the DoS attack disturbs or interrupts a function of a site or a service of the Internet temporarily or indefinitely. Generally, the DoS attack is performed against a well-known site, such as a public office, a bank, etc. Also, a distributed DoS (DDoS) attack is aimed at dispersively disposing a number of attackers and performing the DoS attack at the same time.

Most existing DoS attacks correspond to a type of attack for generating an amount of attack traffic to fill a bandwidth of an attack target network with the corresponding attack traffic and prevent users from using a service of the attack target network, and a type of attack for asking a service providing system to provide an amount of services which the service providing system corresponding to a specific application service cannot afford and thereby preventing users from using the specific application service of the service providing system.

However, a type of DoS attack for not providing users with a specific service related to the attack by continuously managing a session using only a small amount of attack traffic to exhaust all the number of sessions that the server can manage is increasing lately.

As the above type of DoS attacks, a Slowloris attack and a R.U.D.Y attack, which use only a small amount of attack traffic to continuously manage a session connected with the server and occupy server resources for a long time, have been widely known.

A R.U.D.Y attack, which is short for “R U Dead Yet?” or “Are You Dead Yet?”, succeeds by transmitting a whole hypertext transfer protocol (HTTP) POST packet and subsequently transmitting a BODY part very slowly to an attack target server. In an example of analyzing actual attack traffic, R.U.D.Y attacks are sometimes performed by transmitting the BODY part by one byte every 110 seconds to the attack target server.

A Slowloris attack is also a DoS attack using a low bandwidth. According to the Slowloris attack, an incomplete HTTP header is transmitted when setting up connection between a server and a user. The server receives the incomplete HTTP header and waits for the following data. The above connection state is continuously maintained. There is no need to transmit a packet quickly, and only several thousands of packets achieve connection limitation with the server. As such, the server does not deal with requests of other users.

Due to the continuous transmission of such small packets, the type of attack maintaining connection with the server for a long time is not detected using the existing method of determining an attack by the amount of traffic.

### SUMMARY

Accordingly, example embodiments of the present invention are provided to substantially obviate one or more problems due to limitations and disadvantages of the related art.

Example embodiments of the present invention provide a method capable of detecting and blocking a denial-of-service (DoS) attack which is not detected using the existing method because an amount of attack traffic is small.

Example embodiments of the present invention also provide an apparatus suitable for detecting and blocking a DoS attack which is not detected using the existing method because an amount of attack traffic is small.

In some example embodiments, a method of detecting whether or not a specific network session is under a DoS attack includes: detecting a packet transmitted in the session; initializing the number of attack-suspicion continuation packets when the detected packet is a first packet of the session; deriving a size of a body of the detected packet to compare the size of the body of the detected packet with a maximum segment size predetermined for the session, or calculating an arrival-time interval between the detected packet and the previous packet transmitted in the session immediately before the detected packet is transmitted to compare the arrival-time interval with a predetermined permissible arrival-time interval, and when a predefined condition is satisfied, increasing the number of attack-suspicion continuation packets by a predetermined number, and otherwise initializing the number of attack-suspicion continuation packets, and determining that the session is under a DoS attack when the number of attack-suspicion continuation packets is greater than a predetermined minimum number of continuation packets.

In the comparison of the size of the body of the detected packet with the maximum segment size predetermined for the session, the predefined condition may be satisfied when the size of the body of the detected packet is less than the predetermined maximum segment size.

In the comparison of the arrival-time interval between the detected packet and the previous packet transmitted in the session immediately before the detected packet is transmitted with the predetermined permissible arrival-time interval, the predefined condition may be satisfied when the arrival-time interval between the detected packet and the previous packet is greater than the predetermined permissible arrival-time interval.

The method may further include, when the session is determined to be under a DoS attack, blocking the session.

The method may further include: deriving a total size of data to be transmitted using header information of the packet when the detected packet is the first packet of the session; and summing a size of data transmitted through the detected packet and a cumulative value of a size of data transmitted through packets prior to the detected packet in the session, and when the size of the summed data is greater than or equal to the total size of the data to be transmitted, ending determination of whether or not the session is under a DoS attack.

The DoS attack may include a type of attack for continuously maintaining the session using a small amount of traffic, and the packet may include a hypertext transfer protocol (HTTP) POST packet.

The permissible arrival-time interval may be time obtained by adding α to previous calculated round trip time (RTT) of packets in the session, and α may be calculated in consideration of at least one of treatment-time of a server and variation expectation time of the RTT of the packet.

In other example embodiments, an apparatus for detecting a DoS attack in a specific session includes: a packet detecting part configured to detect a packet transmitted in the session; an attack-determination initializing part configured to derive a total size of data to be transmitted using header information of the packet and initialize the number of attack-suspicion continuation packets when the detected packet is a first packet of the session; a determination-end confirming part configured to sum a size of data transmitted through the detected packet and a cumulative value of a size of data transmitted through packets prior to the detected packet in the session, and when the summed data size is greater than or equal to the total size of the data to be transmitted, end determination of whether or not the session is under a DoS attack; a packet analyzing part configured to derive a size of a body of the detected packet to compare the size of the body of the detected packet with a maximum segment size predetermined for the session, or calculate an arrival-time interval between the detected packet and the previous packet transmitted in the session immediately before the detected packet is transmitted to compare the arrival-time interval with a predetermined permissible arrival-time interval, and when a predefined condition is satisfied, increase the number of attack-suspicion continuation packets by a predetermined number, and otherwise initialize the number of attack-suspicion continuation packets; and an attack determining part configured to determine that the session is under a DoS attack when the number of attack-suspicion continuation packets is greater than a predetermined minimum number of continuation packets.

In the comparison of the size of the body of the detected packet with the predetermined maximum segment size, the predefined condition may be satisfied when the size of the body of the detected packet is less than the predetermined maximum segment size.

In the comparison of the arrival-time interval between the detected packet and the previous packet transmitted in the session immediately before the detected packet is transmitted with the predetermined permissible arrival-time interval, the predefined condition may be satisfied when the arrival-time interval between the detected packet and the previous packet is greater than the predetermined permissible arrival-time interval.

The apparatus may further include a session blocking part configured to block the session when the session is determined to be under a DoS attack.

The DoS attack may include a type of attack for continuously maintaining the session using a small amount of traffic, and the packet may include an HTTP POST packet.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing an example of a denial-of-service (DoS) attack using a packet having a small amount of traffic.

FIG. 2 shows data transmitted through a packet used in a DoS attack.

FIG. 3 shows a connection state of a DoS attack target server.

FIG. 4 is a flowchart illustrating a process of detecting a DoS attack based on a size of a packet according to an example embodiment of the present invention.

FIG. 5 is a block diagram showing a structure of an apparatus for detecting a DoS attack based on a size of a packet according to an example embodiment of the present invention.

FIG. 6 is a flowchart illustrating a process of detecting a DoS attack based on an arrival interval between packets according to another example embodiment of the present invention.

FIG. 7 is a block diagram showing a structure of an apparatus for detecting a DoS attack based on an arrival interval between packets according to the other example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention should not be construed as limited to example embodiments of the present invention set forth herein but may be embodied in many alternate forms.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/'acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, a method and apparatus for detecting a denial-of-service (DoS) attack according to example embodiments of the present invention will be described. A DoS attack referred to in example embodiments of the present invention may include a distributed DoS (DDoS) attack. Specifically, although example embodiments of the present invention relate to a method and apparatus for coping with a type of DoS attack for generating a small amount of traffic to maintain a session with a server for a long time and thereby exhaust server resources, the present invention is not limited thereto, and all kinds of DoS attacks may be effectively detected and coped with using a method according to example embodiments of the present invention.

Hereinafter, a method and apparatus for detecting a DoS attacker according to example embodiments of the present invention will be disclosed. Specifically, example embodiments of the present invention relate to a method and apparatus for detecting and coping with a DoS attacker generating a small amount of traffic and maintaining a session with a server for a long time to eventually exhaust server resources, but are not limited thereto, and may effectively detect and cope with similar attacks to the DoS attack.

Hereinafter, when a type of DoS attack using a packet having a small amount of traffic to maintain a session for a long time is performed, an accompanying phenomenon and problem will be examined. Example embodiments of the present invention, which are a method and apparatus for detecting and coping with a DoS attack using characteristics of the type of DoS attack, will be described.

Among types of DoS attacks for continuously transmitting a packet having a small amount of traffic to occupy a session for a long time, a Slowloris attack and a R.U.D.Y. attack are widely known. A R.U.DY. attack, which is short for “R U Dead Yet?” or “Are You Dead Yet?” succeeds by transmitting a whole hypertext transfer protocol (HTTP) POST packet to an attack target server and then transmitting the remaining data very slowly to occupy a session for a long time.

Hereinafter, the type of DoS attack and an accompanying phenomenon will be examined in detail with reference to the accompanying drawings.

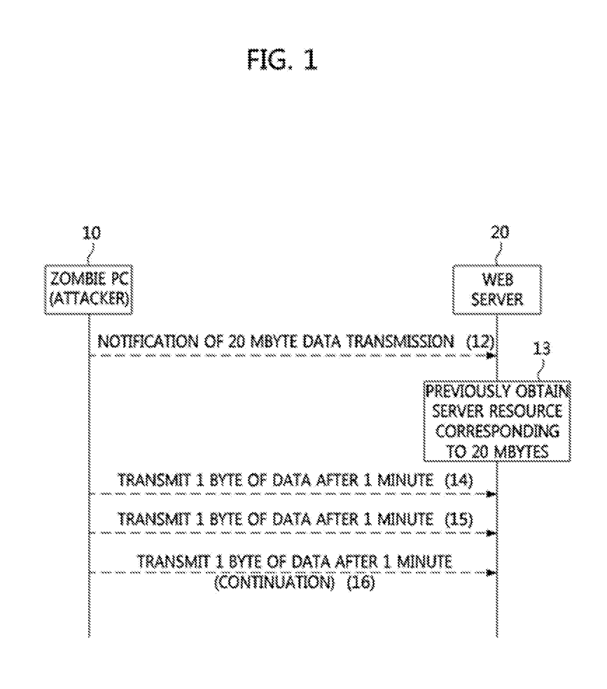

FIG. 1 is a conceptual diagram showing an example of a DoS attack using a packet having a small amount of traffic.

Referring to FIG. 1, a DoS attack, in which a packet having a small amount of traffic is used, may be performed when an attacker's computer 10 occupies a session established with a web server 20 for a long time using packets 14 to 16 of a small amount of traffic.

For example, the attacker's computer 10 may inform the web server 20 that it will transmit 20 Mbytes of data through the packet in step 12. After the web server 20 receives the data transmission communication, the Web server 20 may obtain server resources corresponding to the 20 Mbytes of data in advance in step 13 and may wait.

Next, the attacker's computer 10 may intentionally divide the 20 Mbytes of data into single bytes at 1-minute intervals to transmit the divided 20 Mbytes of data to the web server 20 in step 14 to 16. Finally, a long period of time may elapse while all of the divided 20 Mbytes of data is transmitted. Thus, a chance for the Web server 20 to provide other services corresponding to the same amount of resources may be lost through the occupation of the session for a long time by the attacker's computer 10.

For example, because an Apache web server is able to receive a request body up to 2 gigabytes GBs, the attacker's computer 10 may occupy a connection resource of the Apache Web server 20 for a very long time. Thus, using only a few attackers' systems, all connections the web server 20 is capable of providing may be exhausted, and normal users are unable to receive services.

In particular, when a plurality of zombie computers are used in the above mentioned attack, the server resources may be exhausted in an instant, and it may be impossible to provide the service.

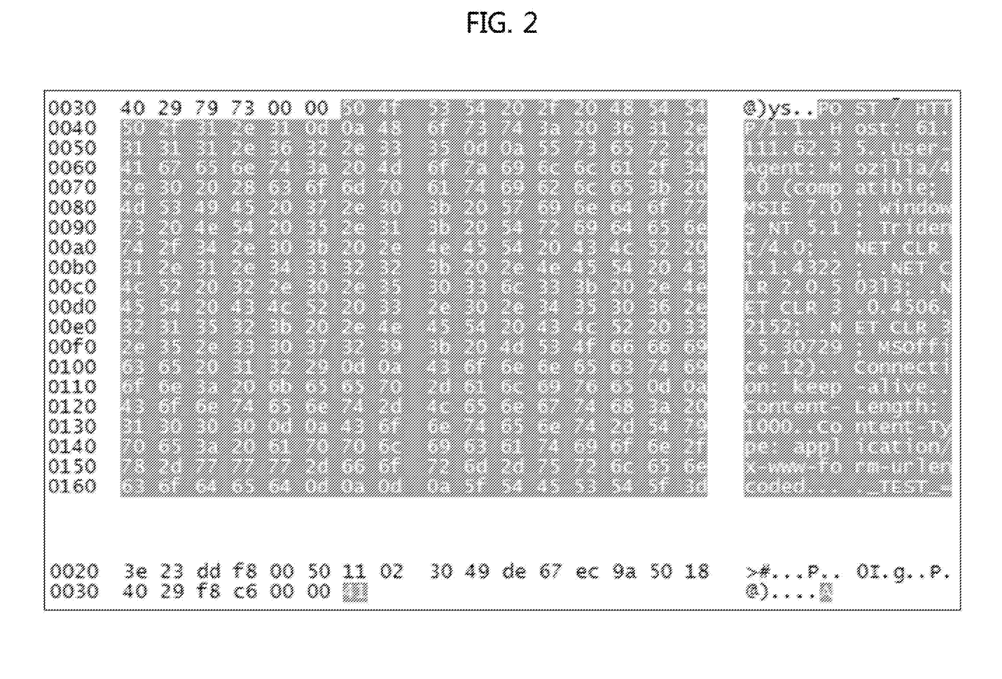

FIG. 2 shows data transmitted through a packet used in a DoS attack.

FIG. 2 shows a slow HTTP POST attack, that is, an actual packet of a R.U.D.Y attack, showing a state in which a letter ‘A’ is transmitted every 100 seconds to an input form named ‘_TEST_’. As such, a total of 1000 ‘A’s may be transmitted.

At this time, when a packet having a small amount of data, as mentioned above, is transmitted for a long time, a case in which resources of a target server are exhausted will be examined in detail with reference to the following accompanying drawings.

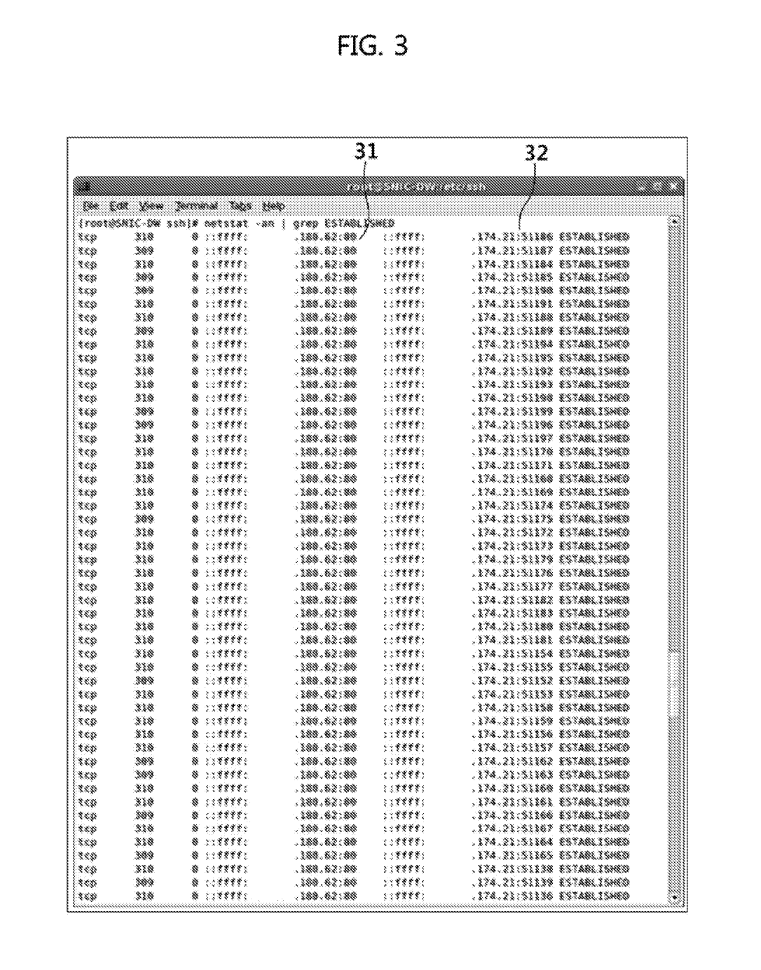

FIG. 3 shows a connection state of a DoS attack target server.

Referring to FIG. 3, an attack 32 through a slow HTTP POST, like a R.U.D.Y attack, may exhaust an available session of a target server 31, that is, may continuously transmit a BODY part of a packet in a small quantity to constantly maintain the session.

Meanwhile, while a general DoS attack may be easily discovered because the amount of traffic of the general DoS is much larger as compared with the amount of normal traffic, because a type of DoS attack in which an incomplete session is maintained such as a R.U.D.Y attack shows a smaller amount of traffic than normal, it is difficult to detect and cope with this type of DoS attack using the existing method.

To detect this type of DoS attack, ModeSecurity, which is an open source web firewall for an Apache web server, may be used to set “RequestReadTimeoutbody” to 30 and counteract this type of DoS attack. This is a method of detecting an attack when an entire request body is not received within 30 seconds. However, when the number of contaminated zombie computers is many, all sessions of the corresponding server may be exhausted within 30 seconds, and thus this method is ineffective in counteracting this type of DoS attack.

On the other hand, there is other method of confirming a size of data set in an input form of a website in advance to detect an attack when a size of data input (or transmitted) through a POST transaction exceeds the previously set size of data. However, because this method requires that all values within a possible range for the corresponding transaction with respect to all POST transactions as well as characteristics of the web server be recognized, this method may generate a problem related to software performance and thereby be ineffective.

Accordingly, to solve the problems described above, example embodiments of the present invention may provide a method and apparatus for determining whether there is a type of DoS attack based on characteristic of the type of DoS attack for maintaining an incomplete session for a long time. That is, example embodiments of the present invention may provide a method and apparatus for effectively detecting whether there is a DoS attack even when the DoS attack is performed through a packet having less traffic than normal.

Hereinafter, a method and apparatus for detecting a DoS attack using a size of a packet transmitted according to a first example embodiment of the present invention will be examined.

A Method and Apparatus for Detecting a DoS Attack According to One Embodiment of the Present Invention

In this example embodiment of the present invention, by analyzing a packet detected in a session, a DoS attack may be determined when a size of a body of more than a constant number of continuous packets is less than the maximum segment size of the session.

That is, in specific circumstances, continuous network packets belonging to one session may be less than a maximum transmission unit (MTU), but in an HTTP POST packet used in a type of attack such as a R.U.D.Y attack, because a packet of which a body is less than the MTU within the one session is not generated more than twice in a row, the type of attack may be determined.

Hereafter, an example embodiment of the present invention will be examined in further detail.

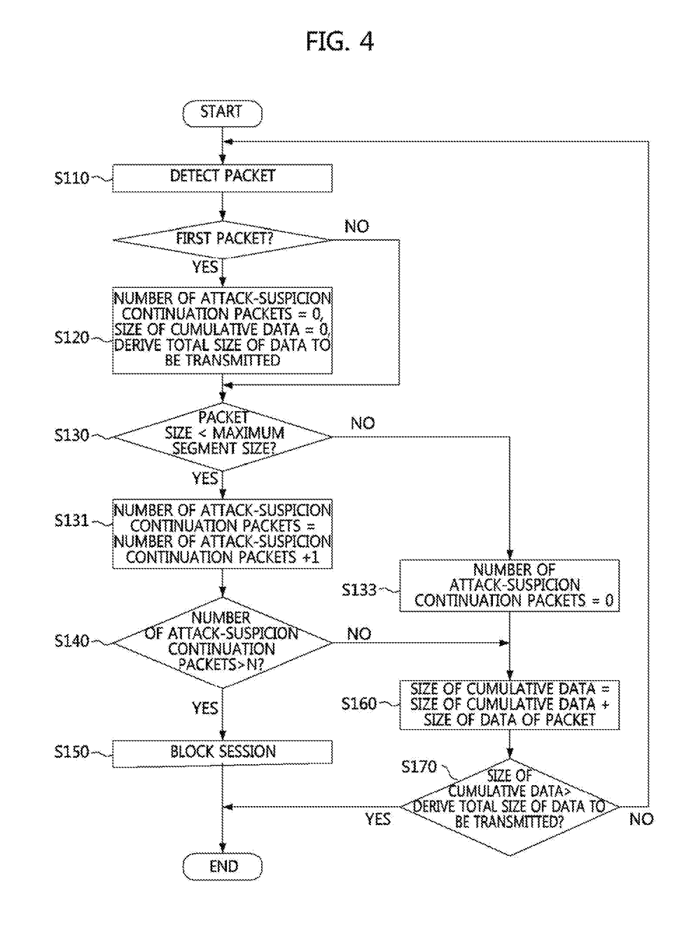

FIG. 4 is a flowchart illustrating a process of detecting a DoS attack based on a size of a packet according to an example embodiment of the present invention.

Referring to FIG. 4, a process of detecting a DoS attack based on a size of a packet according to an example embodiment of the present invention may include a step of detecting a packet S110, a step of initializing attack detection values for a first packet S120, a step of comparing a size of a body of a packet S130, a step of determining whether there is an attack S140, and a step of blocking a session S150.

Hereinafter, each of the above steps will be illustrated with reference to FIG. 4.

To detecting a DoS attack in a specific session, a network packet corresponding to the session may be detected in S110. For example, in a R.U.D.Y attack, an HTTP POST packet may be a detection target.

When the detected packet is a first packet of the session, initialization may be performed, the number of attack-suspicion continuation packets and a size of cumulative data may be set to 0, and a total size of data to be transmitted may be derived using header information of the packet. At this time, the number of attack-suspicion continuation packets may be used to check whether a packet suspected as an attack is continuously received the predetermined number of times. Meanwhile, the size of the cumulative data may be a value for confirming whether all of the intended data has arrived each time the packet is received by summing and cumulating a size of data received through the packet, which may be compared with the total size of the data to be transmitted.

Next, by deriving a size of a body of the detected packet, the predetermined maximum segment size may be compared with the derived body size and the session in S130.

If the derived body size is less than the maximum segment size, 1 may be added to the number of attack-suspicion continuation packet in S131. If the derived body size is not less than the maximum segment size, the number of attack-suspicion continuation packets may be set to 0 in S133.

Also, if the derived body size is less than the maximum segment size, the number of attack-suspicion continuation packets and a predetermined minimum number of continuation packets (for example, 1) may be compared in S140, and if the number of attack-suspicion continuation packets is greater than the minimum number of continuation packets, it may be determined that the session is under a DoS attack, the session may be blocked in S150, and the determination on whether the session is under a DoS attack is terminated.

Meanwhile, when it is determined that the session is not under a DoS attack, the size of the data transmitted through the detected packet may be added to the size of the cumulative data in S160, in which a size of data transmitted through packets prior to the detected packet is accumulated.

Meanwhile, the size of the added data and the total size of the data to be transmitted may be compared in S170, and if the size of the added data is greater, the determination on whether the DoS attack is may be terminated.

Hereinafter, a structure of an apparatus for detecting a DoS attack based on a size of a packet according to an example embodiment of the present invention will be examined.

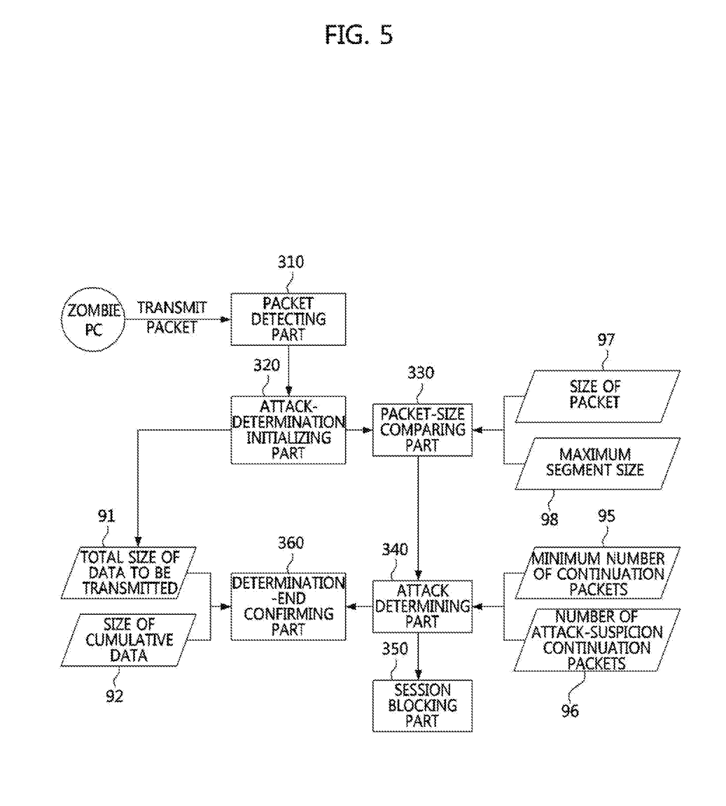

FIG. 5 is a block diagram showing a structure of an apparatus for detecting a DoS attack based on a size of a packet according to an example embodiment of the present invention.

Referring to FIG. 5, an apparatus for detecting a DoS attack according to an example embodiment of the present invention may include a packet detecting part 310, an attack-determination initializing part 320, a packet-size comparing part 330, an attack determining part 340, a session blocking part 350, and a determination-end confirming part 360.

Each of the elements of the apparatus for detecting the DoS attack according to an example embodiment of the present invention may be illustrated as below, with reference to FIG. 5.

The packet detecting part 310 may detect a packet transmitted through the corresponding session to the packet.

When the detected packet is a first packet of the session, the attack-determination initializing part 320 may use header information of the packet to derive a total size of data to be transmitted 91, and may initialize a size of cumulative data 92 transmitted through the packet and the number of attack-suspicion continuation packets 96 by setting them to 0.

The packet-size comparing part 330 may derive a size of a body of the detected packet, and if the derived body size is less than a predetermined maximum segment size 98 for the session, because the detected packet is suspected as a denial-of service attack, may increase the number of the attack-suspicion continuation packets 96 by 1, or otherwise set the number of the attack-suspicion continuation packets 96 to 0.

If the number of the attack-suspicion continuation packets 96 is greater than a predetermined minimum number of continuation packets 95, the attack determining part 340 may determine the DoS attack in the session. When the attack determining part 340 determines the DoS attack in the session, the session blocking part 350 may block the session.

The determination-end confirming part 360 may sum a cumulative value 92 of a size of data transmitted through the detected packet and a size of data transmitted through packets prior to the detected packet in the session, and if the size of the summed data is greater than or equal to the total size of the data to be transmitted 91, may terminate the determination of whether or not the session is under a DoS attack. That is, although it is determined that the session is not under a DoS attack, because all the data has already been received, the determination on whether the session is under a DoS attack does not need to be performed and thus is terminated.

Next, as another example embodiment of the present invention, a method of detecting a DoS attack using an arrival-time interval of a transmitted packet will be examined.

A Method and Apparatus for Detecting a DoS Attack According to Another Embodiment of the Present Invention

In this example embodiment of the present invention, by analyzing a packet detected in session, a DoS attack may be determined when an arrival-time interval of the packet continuously exceeds a permissible arrival-time interval more than a predetermined number of times.

For example, when a normal user transmits continuous data in the same session, because a TCP protocol is set up for transmitting an amount of data as fast as possible, in the worst case, the following packet continuing within a round trip time (RTT) waiting for an ACK packet with respect to the previously transmitted data may be transmitted. Accordingly, in this example embodiment of the present invention, the DoS attack may be determined when the arrival-time interval between packets continuously exceeds the RTT more than the predetermined number of times.

Hereinafter, this example embodiment of the present invention will be examined with reference to the accompanying drawings.

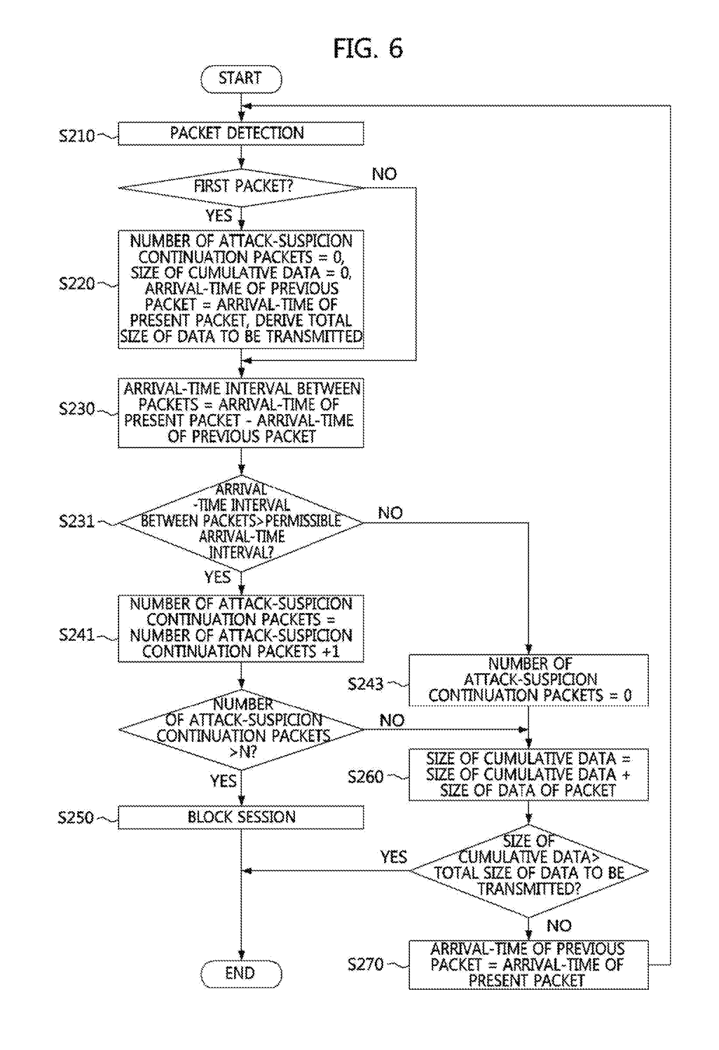

FIG. 6 is a flow chart illustrating a process of detecting a DoS attack based on an arrival interval between packets according to another example embodiment of the present invention.

Referring to FIG. 6, a process of detecting a DoS attack based on an arrival interval according to this example embodiment of the present invention may include a step of detecting a packet S210, a step of initializing attack detection values for a first packet S220, a step of comparing arrival intervals between packets S230, a step of determining whether there is an attack S240, and a step of blocking a session S250.

To detect the DoS attack in a specific session, a network packet corresponding to the session may be detected in S210. For example, in a R.U.D.Y attack, an HTTP POST packet may be a detection target.

When a detected packet is a first packet of the session, initialization may be performed, the number of attack-suspicion continuation packets and a size of cumulative data may be set to 0, and a total size of data to be transmitted may be derived using header information of the packet. Also, arrival time of the present packet may be added to arrival time of the previous packet.

Here, the number of the attack-suspicion continuation packets may be used to check whether a packet suspected as an attack is continuously received the predetermined number of times. Meanwhile, the size of the cumulative data may be a value for confirming whether all of intended data has arrived each time the packet is received by summing and cumulating a size of data received through the packet, and may be compared with the total size of the data to be transmitted.

Next, by subtracting the arrival time of the previous packet from the arrival time of the detected packet, an arrival-time interval between the previous packet and the detected packet may be derived in S230 and the arrival-time interval may be compared with a predetermined permissible arrival-time interval in S231. The predetermined permissible arrival-time may be, for example, RTT of a packet+α, where α may be a value considering a treatment time of a server, variation expectation time of the RTT, etc. For example, a maximum of a that is measured during a predetermined period of a normal state may be also used as the value.

If the arrival-time interval between the packets is greater than the permissible arrival-time interval, it may be determined that the DoS attack is performed in the session, and the number of the attack-suspicion continuation packets may be increased by 1 in S241. Otherwise the number of the attack-suspicion continuation packets may be set to 0 to be initialized in S243.

Next, if the number of the attack-suspicion continuation packets is greater than a predetermined number, that is, for example, if the packets continuously arrive at greater intervals than the permissible arrival-time interval more than the number of two times, it may be determined that the DoS attack is performed in the session and the session may be blocked in S250.

When it is determined that the DoS attack is not performed in the session, a size of data transmitted through the detected packet may be added to the size of the cumulative data in S260, in which a size of data transmitted through packets prior to the detected packet is accumulated. Meanwhile, the size of the added data and the total size of the data to be transmitted may be compared in S270. If the size of the added data is greater than the total size of the data to be transmitted, the determination on whether or not the session is under a DoS attack may be terminated.

Hereinafter, a structure of an apparatus for detecting a DoS attack based on a size of a packet according to the other example embodiment of the present invention will be examined.

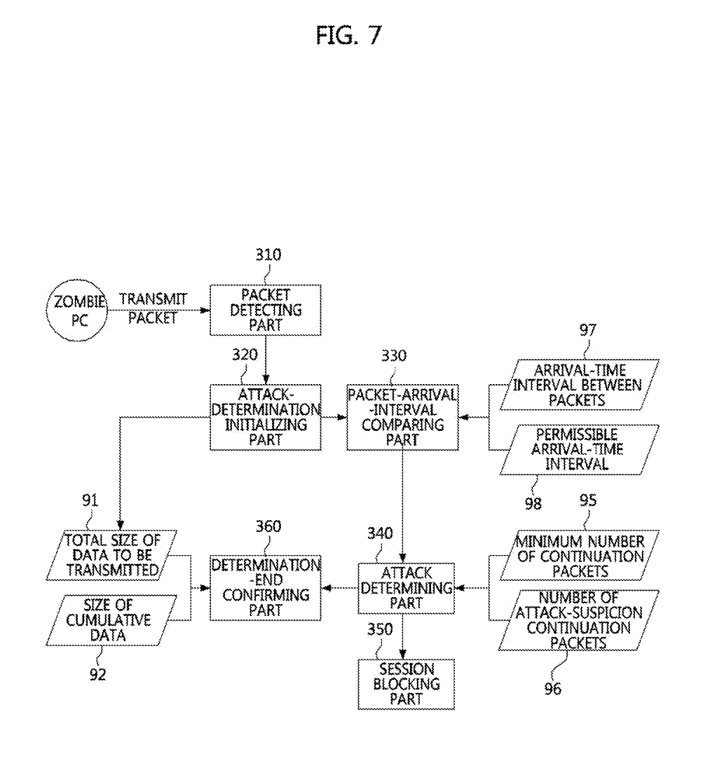

FIG. 7 is a block diagram showing a structure of an apparatus for detecting a DoS attack based on an arrival interval between packets according to the other example embodiment of the present invention.

Referring to FIG. 7, an apparatus for detecting a DoS attack according to this example embodiment of the present invention may include a packet detecting part 310, an attack-determination initializing part 320, a packet-arrival-interval comparing part 335, an attack determining part 340, a session blocking part 350, and a determination-end confirming part 360.

Each of the elements of the apparatus for detecting a DoS attack according to this example embodiment of the present invention may be illustrated as below, with reference to FIG. 7.

The packet detecting part 310 may detect the packet transmitted through the corresponding session to the packet.

When the detected packet is a first packet of the session, the attack-determination initializing part 320 may use header information of the packet to derive a total size of data to be transmitted 91, and may initialize a size of cumulative data 92 transmitted through the packet and the number of attack-suspicion continuation packets 96 by setting them to 0.

When the detected packet is not the first packet of the session, the packet-arrival-interval comparing part 335 may calculate an arrival-time interval 93 between the detected packet and the previous packet transmitted in the session prior to the detected packet to compare the arrival-time interval 93 with a permissible arrival-time interval 94. Also, if the arrival-time interval 93 is greater than the permissible arrival-time interval 94, the number of the attack-suspicion continuation packets 96 may be increased by 1. Otherwise, the number of the attack-suspicion continuation packet 96 may be set to 0.

When the number of the attack-suspicion continuation packets 96 is greater than a predetermined minimum number of continuation packets 95, the attack determining part 340 may determine the DoS attack in the session. When the attack determining part 340 determines the DoS attack in the session, the session blocking part 350 may block the session.

The determination-end confirming part 360 may sum a cumulative value 92 of a size of data transmitted through the detected packet and a size of data transmitted through packets prior to the detected packet in the session, and if the size of the summed data is greater than or equal to the total size of the data to be transmitted 91, may put an end to determination of whether or not the session is under a DoS attack. Even if it is determined that the session is not under a DoS attack, because all the data has already been received, the determination on whether or not the session is under a DoS attack does not need to be performed and thus be terminated.

As described above, the apparatus and method for detecting a DoS attack according to example embodiments of the present invention determine, when a detected packet is analyzed and a packet having a size of a body less than the maximum segment size is continuously transmitted a predetermined number of times or more, the transmission as an attack, or determine, when an arrival interval between packets exceeds a permissible arrival interval between packets in a session more than a predetermined number of times in a row, the packets as an attack, so that an attack of occupying a session for a long time using a packet having a small amount of traffic can be effectively detected and blocked.

While the example embodiments of the present invention and their advantages have been described in detail, it should be understood that various changes, substitutions and alterations may be made herein without departing from the scope of the invention.

What is claimed is:

1. A method of determining whether or not a specific network session is under a denial-of-service (DoS) attack, the method comprising:
detecting a packet transmitted in the session;
initializing a number of attack-suspicion continuation packets when the detected packet is a first packet of the session;
deriving a size of a body of the detected packet to compare the size of the body of the detected packet with a maximum segment size predetermined for the session, and when a predefined condition is satisfied, increasing the number of attack-suspicion continuation packets by a predetermined number, and otherwise initializing the number of attack-suspicion continuation packets; and
determining that the session is under a DoS attack when the number of attack-suspicion continuation packets is greater than a predetermined minimum number of continuation packets.

2. The method of claim 1, wherein the predefined condition is satisfied when the size of the body of the detected packet is less than the predetermined maximum segment size.

3. The method of claim 1, further comprising, when the session is determined to be under the DoS attack, blocking the session.

4. The method of claim 1, further comprising:
deriving a total size of data to be transmitted using header information of the packet when the detected packet is the first packet of the session; and
summing a size of data transmitted through the detected packet and a cumulative value of a size of data transmitted through packets prior to the detected packet in the session, and when the summed data size is greater than or equal to the total size of the data to be transmitted, ending determination of whether or not the session is under a DoS attack.

5. The method of claim 1, wherein the DoS attack includes a type of an attack for continuously maintaining the session using a small amount of traffic, and
the packet includes a hypertext transfer protocol (HTTP) POST packet.

6. A method of determining whether or not a specific network session is under a denial-of-service (DoS) attack, the method comprising:
detecting a packet transmitted in the session;
initializing a number of attack-suspicion continuation packets when the detected packet is a first packet of the session;
calculating an arrival-time interval between the detected packet and the previous packet transmitted in the session immediately before the detected packet is transmitted to compare the arrival-time interval with a predetermined permissible arrival-time interval, and when a predefined condition is satisfied, increasing the number of attack-suspicion continuation packets by a predetermined number, and otherwise initializing the number of attack-suspicion continuation packets; and
determining that the session is under a DoS attack when the number of attack-suspicion continuation packets is greater than a predetermined minimum number of continuation packets.

7. The method of claim 6, wherein, the predefined condition is satisfied when the arrival-time interval between the detected packet and the previous packet is greater than the predetermined permissible arrival-time interval.

8. The method of claim 6, further comprising, when the session is determined to be under the DoS attack, blocking the session.

9. The method of claim 6, further comprising:
deriving a total size of data to be transmitted using header information of the packet when the detected packet is the first packet of the session; and
summing a size of data transmitted through the detected packet and a cumulative value of a size of data transmitted through packets prior to the detected packet in the session, and when the summed data size is greater than or equal to the total size of the data to be transmitted, ending determination of whether or not the session is under a DoS attack.

10. The method of claim 6, wherein the DoS attack includes a type of an attack for continuously maintaining the session using a small amount of traffic, and
the packet includes a hypertext transfer protocol (HTTP) POST packet.

11. The method of claim 6, wherein the permissible arrival-time interval is time obtained by adding α to previously calculated round trip time (RTT) of packets in the session,
wherein α is calculated in consideration of at least one of treatment time of a server and variation expectation time of the RTT of the packet.

12. An apparatus for determining whether a specific network session is under a denial-of-service (DoS) attack, the apparatus comprising:
a packet detecting part configured to detect a packet transmitted in the session;
an attack-determination initializing part configured to derive a total size of data to be transmitted using header information of the packet and initialize a number of attack-suspicion continuation packets when the detected packet is a first packet of the session;
a determination-end confirming part configured to sum a size of data transmitted through the detected packet and a cumulative value of a size of data transmitted through packets prior to the detected packet in the session, and when the summed data size is greater than or equal to a total size of the data to be transmitted, end determination of whether the session is under a DoS attack;
a packet analyzing part configured to derive a size of a body of the detected packet to compare the size of the body of the detected packet with a maximum segment size predetermined for the session, and when a predefined condition is satisfied, increase the number of attack-suspicion continuation packets by a predetermined number, and otherwise initialize the number of attack-suspicion continuation packets; and
an attack determining part configured to determine that the session is under a DoS attack when the number of attack-suspicion continuation packets is greater than a predetermined minimum number of continuation packets.

13. The apparatus of claim 12, wherein, the predefined condition is satisfied when the size of the body of the detected packet is less than the predetermined maximum segment size.

14. The apparatus of claim 12, further comprising a session blocking part configured to block the session when the session is determined to be under a DoS attack.

15. The apparatus of claim 12, wherein the DoS attack includes a type of an attack for continuously maintaining the session using a small amount of traffic, and
the packet includes a hypertext transfer protocol (HTTP) POST packet.

16. An apparatus for determining whether a specific network session is under a denial-of-service (DoS) attack, the apparatus comprising:
a packet detecting part configured to detect a packet transmitted in the session;
an attack-determination initializing part configured to derive a total size of data to be transmitted using header information of the packet and initialize a number of attack-suspicion continuation packets when the detected packet is a first packet of the session;
a determination-end confirming part configured to sum a size of data transmitted through the detected packet and a cumulative value of a size of data transmitted through packets prior to the detected packet in the session, and when the summed data size is greater than or equal to a total size of the data to be transmitted, end determination of whether the session is under a DoS attack;
calculate an arrival-time interval between the detected packet and the previous packet transmitted in the session immediately before the detected packet is transmitted to compare the arrival-time interval with a predetermined permissible arrival-time interval, and when a predefined condition is satisfied, increase the number of attack-suspicion continuation packets by a predetermined number, and otherwise initialize the number of attack-suspicion continuation packets; and
an attack determining part configured to determine that the session is under a DoS attack when the number of attack-suspicion continuation packets is greater than a predetermined minimum number of continuation packets.

17. The apparatus of claim 16, wherein, the predefined condition is satisfied when the arrival-time interval between the detected packet and the previous packet is greater than the predetermined permissible arrival-time interval.

18. The apparatus of claim 16, further comprising a session blocking part configured to block the session when the session is determined to be under a DoS attack.

19. The apparatus of claim 16, wherein the DoS attack includes a type of an attack for continuously maintaining the session using a small amount of traffic, and
the packet includes a hypertext transfer protocol (HTTP) POST packet.
